(19) United States
(12) Patent Application Publication
(10) Pub. No.: US 2014/0247585 A1
(43) Pub. Date: Sep. 4, 2014

(54) SEMICONDUCTOR LIGHTING APPARATUS

(71) Applicant: UNISTARS CORPORATION, Hsinchu County (TW)

(72) Inventors: Wen-Cheng CHIEN, Hsinchu City (TW); Shang-Yi WU, Hsinchu City (TW); Shin-Shien SHIE, Taoyuan County (TW)

(73) Assignee: UNISTARS CORPORATION, Hsinchu County (TW)

(21) Appl. No.: 13/781,768

(22) Filed: Mar. 1, 2013

(51) Int. Cl. F21V 19/00

(52) U.S. Cl. CPC F21V 19/003
USPC 362/217.17

(57) ABSTRACT

A semiconductor lighting apparatus includes an illumination module and a power module. The illumination module includes a supporting member, a semiconductor light-emitting element, an electrode structure and a first connecting member. The semiconductor light-emitting element is mounted on the supporting member and electrically connected with the electrode structure. The first connecting member is mounted on a first side of the supporting member. The power module is configured to connect to the first side of the supporting member, and includes a second connecting member and a driving circuit member. The second connecting member is detachably connected with the first connecting member. The driving circuit member is electrically connected with the second connecting member and electrically connected with the electrode structure to provide a driving power to the semiconductor light-emitting element.

### FIELD OF THE INVENTION

The present invention relates to a lighting apparatus, and more particularly to a semiconductor lighting apparatus.

### BACKGROUND OF THE INVENTION

A semiconductor lighting apparatus is a lighting apparatus that uses a semiconductor device as a light source. For example, a light emitting diode (LED) is a semiconductor device capable of converting electrical energy into visible light and radiation energy. When an electric current passes through the LED, electrons recombine with holes and the extra energy is released in the form of light. Since LED has many benefits such as low power consumption, long service life, quick response speed, small volume and anti-vibration, LED is feasible for mass production.

Conventionally, a driving circuit board is fixed within a LED lamp tube. If the LED or the driving circuit board is damaged, the whole LED lamp tube need to be discarded. Generally, the usage lifespan of the LED is much longer than the usage lifespan of the driving circuit board. If the whole LED lamp tube is discarded because of the damage of the driving circuit board, the problem of excessively wasting resources occurs.

Therefore, there is a need of providing an improved semiconductor lighting apparatus so as to eliminate the above drawbacks.

### SUMMARY OF THE INVENTION

The present invention provides a semiconductor lighting apparatus. Consequently, even if the driving circuit board is damaged, defective or broken, it is not necessary to discard the whole semiconductor lighting apparatus.

In accordance with an aspect, the present invention provides a semiconductor lighting apparatus. The semiconductor lighting apparatus includes an illumination module and a power module. The illumination module includes a supporting member, a semiconductor light-emitting element, an electrode structure and a first connecting member. The semiconductor light-emitting element is mounted on the supporting member and electrically connected with the electrode structure. The first connecting member is located at a first side of the supporting member. The power module is configured to connect to the first side of the supporting member, and includes a second connecting member and a driving circuit member. The second connecting member is detachably connected with the first connecting member. The driving circuit member is electrically connected with the second connecting member and electrically connected with the electrode structure to provide a driving power to the semiconductor light-emitting element.

In an embodiment, one of the first connecting member and the second connecting member has at least one first concave conductor, and the other one of the first connecting member and the second connecting member has at least one first protruding conductor. The at least one first protruding conductor is inserted into the at least one first concave conductor, so that the illumination module and the power module are electrically connected with each other.

In an embodiment, one of the first connecting member and the second connecting member has an outer thread structure, and the other one of the first connecting member and the second connecting member has an inner thread structure. The outer thread structure and the inner thread structure are engaged with each other, so that the illumination module and the power module are electrically connected with each other.

In an embodiment, the power module further includes at least one second convex conductor to be electrically connected with an external power source.

In an embodiment, the power module further includes a sleeve. The second connecting member is mounted on a first end of the sleeve. At least one second protruding conductor is mounted on a second end of the sleeve, wherein the first end and the second end of the sleeve are arranged in opposite facing directions from each other and the driving circuit member is disposed within the sleeve.

In an embodiment, the semiconductor lighting apparatus further includes a lamp shade. After the lamp shade is connected with the supporting member, the semiconductor lighting apparatus has a lamp tube profile. The semiconductor light-emitting element and the electrode structure are mounted on a bottom of the supporting member.

In an embodiment, the semiconductor lighting apparatus further includes a lamp shade. After the lamp shade is connected with a second side of the supporting member, the semiconductor lighting apparatus has a bulb profile. The second side of the supporting member is opposite from the first side of the supporting member. The semiconductor light-emitting element and the electrode structure are mounted on an inner surface of the supporting member.

In an embodiment, the power module is configured to receive an AC voltage and convert the AC voltage into a DC voltage, which is used as the driving power.

In an embodiment, the semiconductor lighting apparatus further includes an additional illumination module and an additional power module. The additional illumination module and the illumination module have identical configurations. The additional power module and the power module have identical configurations. The additional illumination module and the illumination module are arranged between the additional power module and the power module. The additional power module and the power module are electrically connected with each other.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic exploded view illustrating a semiconductor lighting apparatus according to a first embodiment of the present invention;

FIG. 2 is a schematic partial exploded view illustrating an illumination module of the semiconductor lighting apparatus of FIG. 1;

FIG. 3 is a schematic cross-sectional view illustrating an illumination module of the semiconductor lighting apparatus of FIG. 1 taken along the line AA;

FIG. 4 is a schematic exploded view illustrating a power module of the semiconductor lighting apparatus according to the first embodiment of the present invention;

FIG. 5 schematically illustrates a circuit layout of a semiconductor lighting apparatus according to an embodiment of the present invention;

FIG. 6 is a schematic perspective view illustrating a semiconductor lighting apparatus according to a second embodiment of the present invention; and

FIG. 7 is a schematic exploded view illustrating the semiconductor lighting apparatus of FIG. 6.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

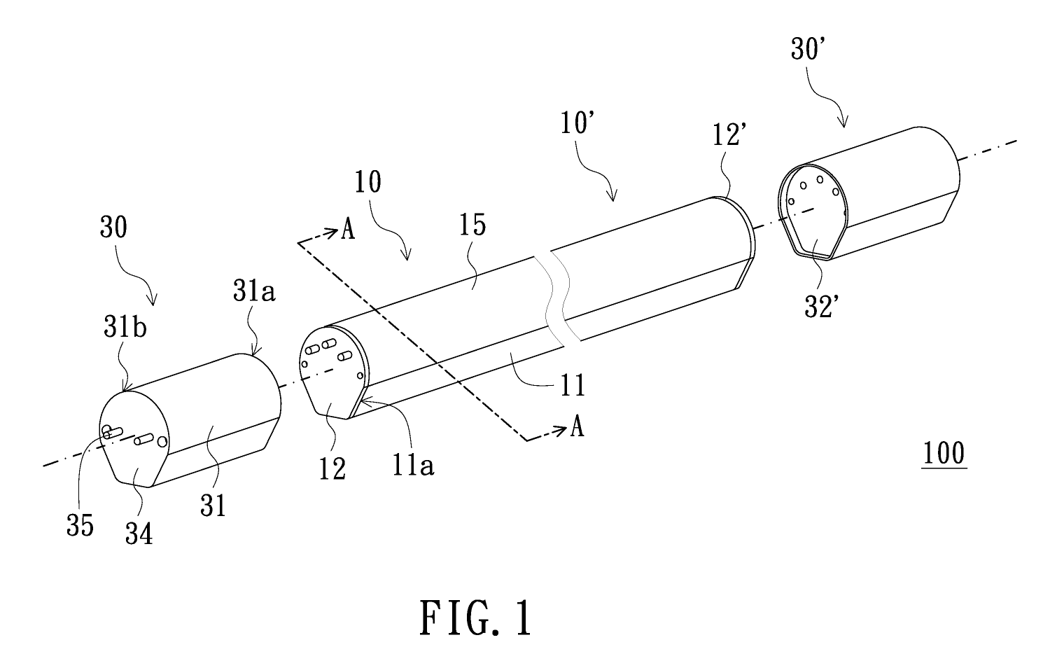

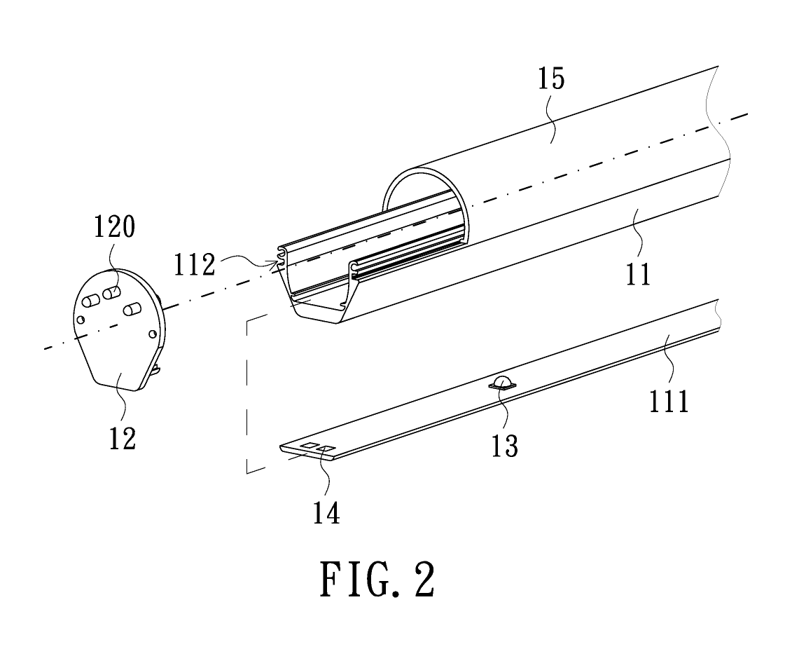

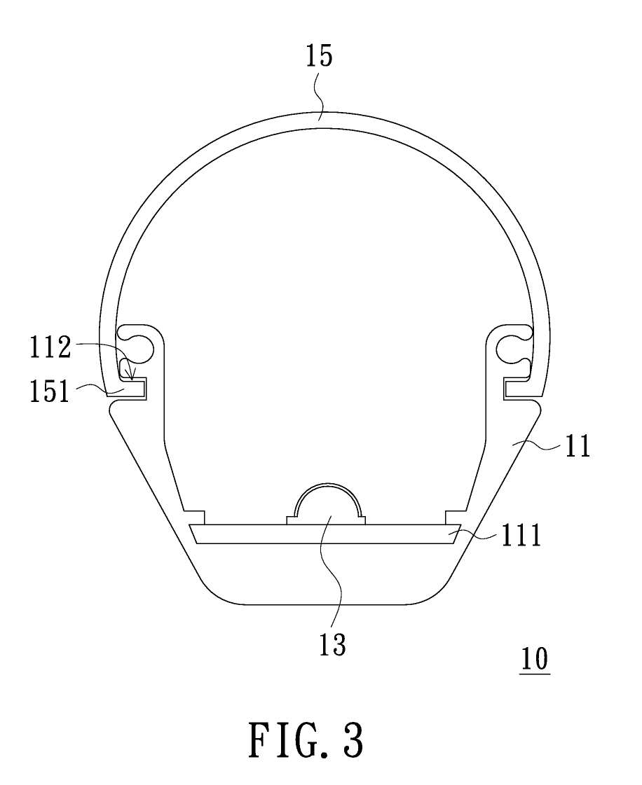

Hereinafter, a semiconductor lighting apparatus according to a first embodiment of the present invention will be illustrated with reference to FIGS. 1, 2 and 3. FIG. 1 is a schematic exploded view illustrating a semiconductor lighting apparatus 100 according to a first embodiment of the present invention. FIG. 2 is a schematic partial exploded view illustrating an illumination module of the semiconductor lighting apparatus 100 of FIG. 1. FIG. 3 is a schematic cross-sectional view illustrating the illumination module of the semiconductor lighting apparatus 100 of FIG. 1 taken along the line AA.

As shown in FIG. 1, the semiconductor lighting apparatus 100 comprises an illumination module 10 and a power module 30. The power module 30 is located at an outer side of the illumination module 10. As shown in FIG. 2, the illumination module 10 comprises a supporting member 11, a semiconductor light-emitting element 13, an electrode structure 14, and a first connecting member 12. The semiconductor light-emitting element 13 is, for example, a light emitting diode (LED). Alternatively, in some other embodiments, the illumination module 10 may include a plurality of semiconductor light-emitting elements 13. As shown in FIG. 3, the supporting member 11 is an elongated groove structure. The semiconductor light-emitting element 13 and the electrode structure 14 are mounted on a bottom of the supporting member 11. Moreover, the first connecting member 12 is mounted on a first side 11a of the supporting member 11. The electrode structure 14 is located near the first side 11a of the supporting member 11 for facilitating electrical connection between the first connecting member 12 and the electrode structure 14. The electrode structure 14 is also electrically connected with the semiconductor light-emitting element 13. Moreover, the electrode structure 14 may be electrically connected with the first connecting member 12 and the semiconductor light-emitting element 13 via electrical wires (not shown). In this embodiment, the supporting member 11 further comprises an aluminum substrate 111. The aluminum substrate 111, disposed on the bottom of the groove structure of the supporting member 11, may thereby form as an upper surface of the supporting member 11. Consequently, the semiconductor light-emitting element 13 and the electrode structure 14 may be mounted on the aluminum substrate 111. For enhancing the heat-dissipating efficiency of the illumination module 10, the supporting member 11 is made of a metallic material such as aluminum.

Moreover, the semiconductor lighting apparatus 100 further comprises a lamp shade 15. Corresponding to a protrusion rim 151 of the lamp shape 15, an elongated recess 112 is formed in the outer surface of the supporting member 11. When the protrusion edge 151 of the lamp shape 15 is fittingly engaged into the elongated recess 112, the lamp shade 15 is fixedly attached on the supporting member 11. After the supporting member 11, the lamp shade 15 and the first connecting member 12 are combined together, the semiconductor lighting apparatus 100 configured with the lamp tube profile is thereby fabricated. Meanwhile, the entrance or opening at the first side 11a of the supporting member 11 is closed.

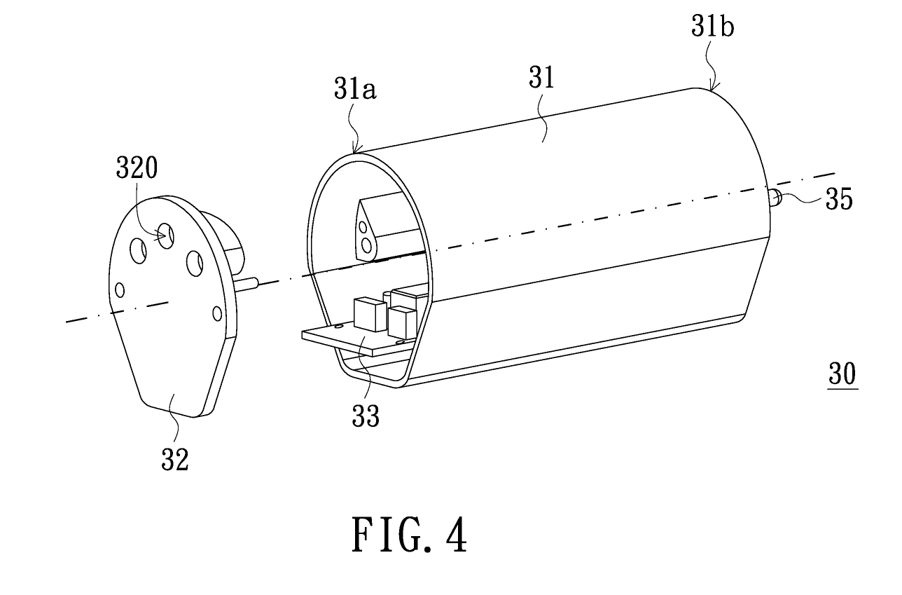

FIG. 4 is a schematic exploded view illustrating a power module 30 of the semiconductor lighting apparatus 100 according to the first embodiment of the present invention. Please refer to FIG. 1 and FIG. 4. The power module 30 is is configured to connect to the first side 11a of the supporting member 11. Moreover, the power module 30 comprises a second connecting member 32 and a driving circuit member 33 (e.g. a driving circuit board). The second connecting member 32 of the power module 30 is configured to be engaged with the first connecting member 12 of the illumination module 10, so that the power module 30 and the illumination module 10 are combined together. The driving circuit member 33 is electrically connected with the second connecting member 32. Consequently, the driving circuit member 33 can be electrically connected with the electrode structure 14 in order to provide driving power to the semiconductor light-emitting element 13. In this embodiment, the power module 30 further comprises a sleeve 31 for covering the driving circuit member 33. The sleeve 31 has a first end 31a and a second end 31b, wherein the first end 31a and the second end 31b are opposite from each other. Moreover, the first end 31a of the sleeve 31 is configured to connect to the second connecting member 32.

It is noted that the second connecting member 32 and the first connecting member 12 are configured to be detachably-connected with each other. For example, the first connecting member 12 has plural first protruding conductors 120 (see FIG. 2), and the second connecting member 32 has plural first concave conductors 320 (see FIG. 4) (the first concave conductors 320 have recessed openings). The number and the positions of the first protruding conductors 120 match the number and the positions of the first concave conductors 320. After the first protruding conductors 120 are inserted into corresponding first concave conductors 320, the first connecting member 12 and the second connecting member 32 are combined together. Consequently, the illumination module 10 and the power module 30 are then electrically connected with each other. It is noted that numerous modifications and alterations may be made while retaining the teachings of the invention. For example, in some other embodiments, the first connecting member 12 has plural concave conductors, and the second connecting member 32 has plural protruding conductors corresponding to the plural concave conductors. That is, the method of electrically connecting the illumination module 10 with the power module 30 is presented herein for purpose of illustration and description only. Therefore, the first connecting member 12 and the second connecting member 32 can be easily detached from each other. Consequently, if the power module 30 ever becomes broken or non-functional, the power module 30 can be easily detached from the illumination module 10 by the user himself, and be replaced with a new one. Then, the new power module 30 can be easily combined or attached with the original illumination module 10. Since it is not necessary to discard the whole semiconductor lighting apparatus 100, the purpose of saving resources is thereby achieved.

In an embodiment, the first protruding conductors 120 may be in the form or structure of a plurality of posts, and the first concave conductors 320 may be in the form or structure of a plurality of openings corresponding to the posts. Due to the convenient detachable engagement capability found between the posts and the openings, the first connecting member 12 and the second connecting member 32 are fittingly engageably combined together.

The other remaining components may be securely amounted or assembled on associated structures without the need of using the detachable connecting manner. For example, during assembly process in factories, the other remaining components may be securely latched on associated structures by screwing means or latched each other, a surface-mount technology (SMT), or together have a one-piece structure in order to enhance the reliability of the whole semiconductor lighting apparatus.

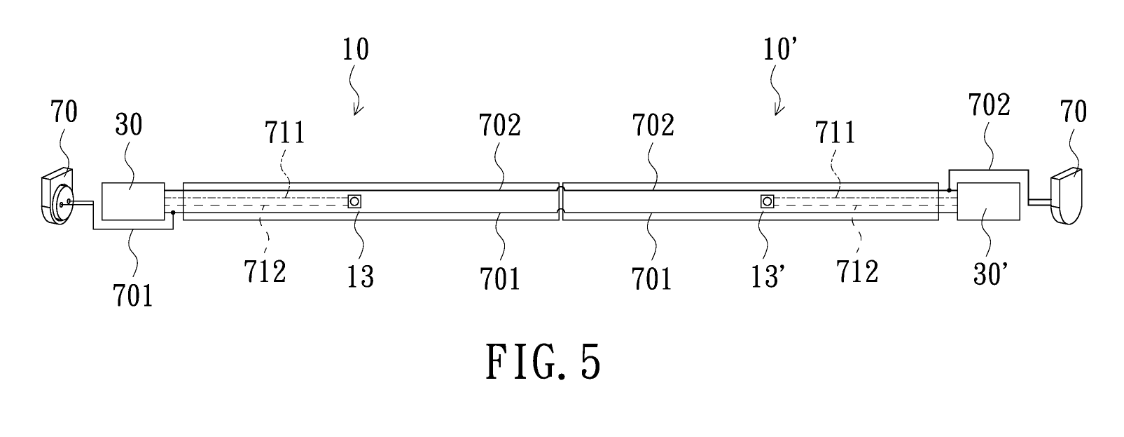

FIG. 5 schematically illustrates a circuit layout of a semiconductor lighting apparatus according to an embodiment of the present invention. Referring to FIG. 1 and FIG. 5, the semiconductor lighting apparatus 100 comprises an illumination module 10, a power module 30, an additional illumination module 10′ and an additional power module 30′. The configurations of the additional illumination module 10′ and the additional power module 30′ are identical to those of the illumination module 10 and the power module 30, respectively. The illumination module 10 and the additional illumination module 10′ are electrically connected with each other. Moreover, the illumination module 10 and the additional illumination module 10′ are arranged between the two power modules 30 and 30′, and are electrically connected with the two power modules 30 and 30′. The second connecting member 32′ of the power module 30′ and the first connecting member 12′ of the additional illumination module 10′ are detachably connected with each other. Moreover, the power module 30 further comprises two second protruding conductors 35. The two second protruding conductors 35 are opposite from the second connecting member 32 (see FIG. 4). That is, the second protruding conductor 35 is located near the second end 3 lb of the sleeve 31. In this embodiment, the power module 30 further comprises a side plate 34, which is mounted at the second end 31b of the sleeve 31. The second protruding conductor 35 is disposed on the side plate 34 (see FIG. 1). The configurations of the additional power module 30′ are similar or identical to those of the power module 30, and are not redundantly described herein.

The semiconductor lighting apparatus 100 may be installed in two conventional fluorescent lamp holders 70. The second protruding conductors 35 of the power module 30 and the second protruding conductors (not shown) of the additional power module 30′ are configured to be electrically-connected to the two conventional fluorescent lamp holders 70 at both ends of the semiconductor lighting apparatus 100. By using the power modules 30 and 30′, the AC voltage from the fluorescent lamp holders 70 is converted into a DC voltage, which is used as the driving power for driving the semiconductor light-emitting elements 13 and 13′. As shown in FIG. 5, the fluorescent lamp holders 70 are electrically connected with the power modules 30 and 30′ through the AC live line 701 and the AC neutral line 702. After the AC voltage is converted into the DC voltage by the driving circuit members of the power modules 30 and 30′, the DC voltage (i.e. the driving power) is transmitted to the semiconductor light-emitting elements 13 and 13′ through a positive output terminal 711 and a negative output terminal 712. Consequently, the semiconductor lighting apparatus 100 is lighted up.

During operations of the semiconductor lighting apparatus 100, if one of the illumination modules 10 and 10′ fails to emit the light beam, it may be inferred that the corresponding power module 30 or 30′ is possibly damaged. Under this circumstance, the damaged power module may be easily replaced with a new one. In other words, it is not necessary to discard the whole semiconductor lighting apparatus 100 when only the power module is damaged.

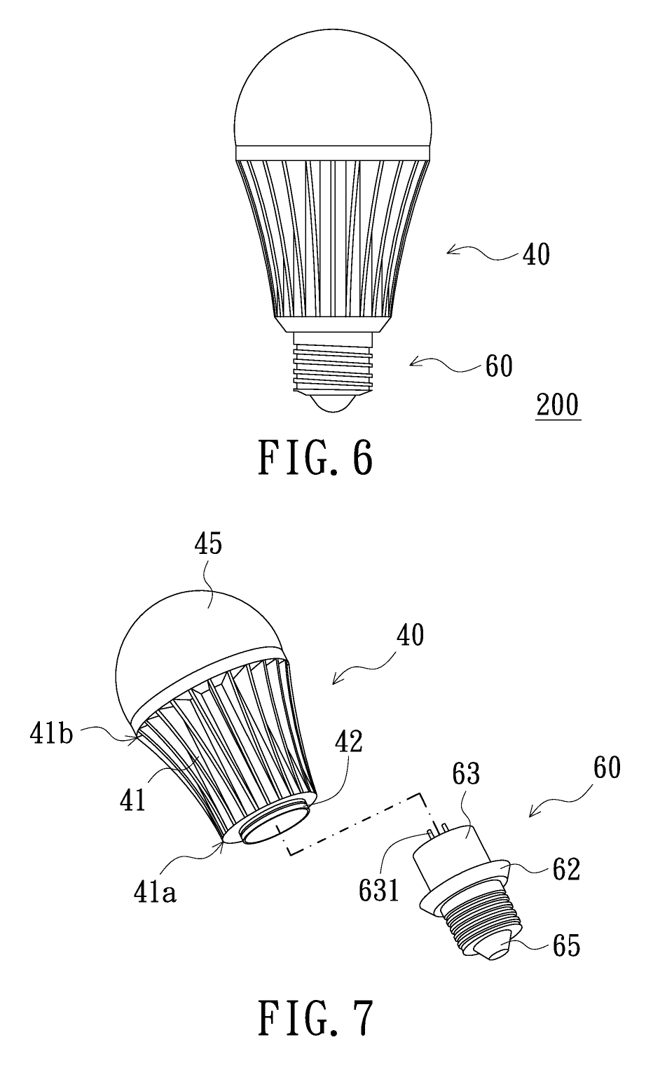

In the above embodiment, the semiconductor lighting apparatus has a lamp tube profile in structure or shape. It is noted that the outward appearance of the semiconductor lighting apparatus may be configured and varied according to the practical requirements. FIG. 6 is a schematic perspective view illustrating a semiconductor lighting apparatus according to a second embodiment of the present invention. FIG. 7 is a schematic exploded view illustrating the semiconductor lighting apparatus of FIG. 6. In this embodiment, the semiconductor lighting apparatus 200 has a bulb profile in shape. Except for the following components, the other components and their relationships of the semiconductor lighting apparatus 200 are similar to those of the semiconductor lighting apparatus of the first embodiment, and are not redundantly described herein. As shown in FIG. 6, the semiconductor lighting apparatus 200 comprises an illumination module 40 and a power module 60. The illumination module 40 and the power module 60 are detachably connected with each other. In this embodiment, a supporting member 41 of the illumination module 40 is a hollow ring-shaped structure. A semiconductor light-emitting element (not shown) and an electrode structure (not shown) are fixed on an inner surface of the supporting member 41. Moreover, a first connecting member 42 is located at a first side 41 a of the supporting member 41. The first connecting member 42 has an outer threaded structure. Corresponding to the outer thread structure, a second connecting member 62 of the power module 60 has an inner thread structure. After the outer thread structure and the inner thread structure are engaged with each other, the first connecting member 42 and the second connecting member 62 are combined together. Consequently, a driving circuit member 63 of the power module 60 is inserted into the supporting member 41, and electrically connected with the electrode structure of the illumination module 40. It is noted that numerous modifications and alterations may be made while retaining the teachings of the invention. For example, in some other embodiments, the first connecting member 42 has an inner thread structure, and the second connecting member 62 has an outer thread structure corresponding to the inner thread structure of the first connecting member 42. Moreover, a bottom of the power module 60 further comprises a second convex conductor 65. The second convex conductor 65 may be inserted into a power socket (not shown) to receive an AC voltage. By using the driving circuit member 63 of the power module 60, the AC voltage is converted into a DC voltage. The DC voltage is transmitted to the electrode structure of the illumination module 40 through the positive/negative electrodes 631 of the power module 60. Consequently, the DC voltage is further transmitted to the semiconductor light-emitting element of the illumination module 40.

Moreover, the semiconductor lighting apparatus 200 further comprises a lamp shade 45. The lamp shade 45 is mounted on a second side 41b of the supporting member 41, wherein the second side 41b is opposite from the first side 41a. After the supporting member 41, the lamp shade 45, the first connecting member 42 and the second connecting member 62 are combined together, the semiconductor lighting apparatus 200 configured with the bulb profile is thereby fabricated. Similarly, the power module 60 of the semiconductor lighting apparatus 200 may be easily replaced with a new one.

Alternatively, in some embodiments, the power module of the semiconductor lighting apparatus is mounted on an end or an outer surface of the illumination module. Moreover, the driving circuit member is detachably connected to the power module. In a case that the driving circuit member ever becomes broken or non-functional, the driving circuit member may be easily detached from the power module by the user himself and replaced with a new one. Under this circumstance, the purpose of the present invention is also achievable.

From the above descriptions, the present invention provides a semiconductor lighting apparatus. The semiconductor lighting apparatus comprises an illumination module and a power module. The illumination module and the power module are independent module units, and are detachably connected with each other through corresponding connecting members. Consequently, if the power module is failed, the power module may be replaced with a new one, but the illumination module is retained or kept remaining in usage. Under this circumstance, it is not necessary to discard the whole semiconductor lighting apparatus, so that the resources can be effectively utilized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A semiconductor lighting apparatus, comprising:
an illumination module comprising a supporting member, a semiconductor light-emitting element, an electrode structure and a first connecting member, wherein the semiconductor light-emitting element is mounted on the supporting member and electrically connected with the electrode structure, and the first connecting member is mounted on a first side of the supporting member; and
a power module configured to connect to the first side of the supporting member, and comprising a second connecting member and a driving circuit member, wherein the second connecting member is detachably connected with the first connecting member, wherein the driving circuit member is electrically connected with the second connecting member, and electrically connected with the electrode structure to provide a driving power to the semiconductor light-emitting element.

2. The semiconductor lighting apparatus according to claim 1, wherein one of the first connecting member and the second connecting member has at least one first concave conductor, and the other one of the first connecting member and the second connecting member has at least one first protruding conductor, wherein the at least one first protruding conductor is inserted into the at least one first concave conductor, so that the illumination module and the power module are electrically connected with each other.

3. The semiconductor lighting apparatus according to claim 1, wherein one of the first connecting member and the second connecting member has an outer thread structure, and the other one of the first connecting member and the second connecting member has an inner thread structure, wherein the outer thread structure and the inner thread structure are engaged with each other, so that the illumination module and the power module are electrically connected with each other.

4. The semiconductor lighting apparatus according to claim 1, wherein the power module further comprises at least one second protruding conductor to be electrically connected with an external power source.

5. The semiconductor lighting apparatus according to claim 4, wherein the power module further comprises a sleeve, wherein the second connecting member is mounted on a first end of the sleeve, and the at least one second protruding conductor is mounted on a second end of the sleeve, wherein the first end and the second end of the sleeve are located opposite from each other and the driving circuit member is disposed within the sleeve.

6. The semiconductor lighting apparatus according to claim 1, wherein the semiconductor lighting apparatus further comprises a lamp shade, wherein after the lamp shade is connected with the supporting member, the semiconductor lighting apparatus has a lamp tube profile, wherein the semiconductor light-emitting element and the electrode structure are mounted on a bottom of the supporting member.

7. The semiconductor lighting apparatus according to claim 1, wherein the semiconductor lighting apparatus further comprises a lamp shade, wherein after the lamp shade is mounted on a second side of the supporting member, the semiconductor lighting apparatus has a bulb profile, wherein the second side of the supporting member is opposite from the first side of the supporting member, and the semiconductor light-emitting element and the electrode structure are mounted on an inner surface of the supporting member.

8. The semiconductor lighting apparatus according to claim 1, wherein the power module is configured to receive an AC voltage and convert the AC voltage into a DC voltage, which is used as the driving power.

9. The semiconductor lighting apparatus according to claim 1, wherein the semiconductor lighting apparatus further comprises an additional illumination module and an additional power module, the additional illumination module and the illumination module have identical configurations, and the additional power module and the power module have identical configurations, the additional illumination module and the illumination module are arranged between the additional power module and the power module, the additional power module and the power module are electrically connected with each other.
